(19) United States
(12) Patent Application Publication
(10) Pub. No.: US 2021/0367788 A1
(43) Pub. Date: Nov. 25, 2021

(54) DIGITAL RE-SIGNING METHOD FOR SUPPORTING VARIOUS DIGITAL SIGNATURE ALGORITHMS IN SECURE SOCKETS LAYER DECRYPTION APPARATUS

(71) Applicant: SOOSAN INT CO., LTD., Seoul (KR)

(72) Inventors: Chul Woong YANG, Daejeon (KR); Woo Suk YANG, Daejeon (KR)

(73) Assignee: Soosan INT Co., Ltd., Seoul (KR)

(21) Appl. No.: 16/974,310

(22) PCT Filed: Aug. 6, 2019
(86) PCT No.: PCT/KR2019/009804

§ 371 Date: Dec. 28, 2020

(30) Foreign Application Priority Data
Jun. 27, 2018 (KR) 10-2018-0074041

(51) Int. Cl. H04L 9/32; H04L 9/08; H04L 29/06

(52) U.S. Cl. CPC H04L 9/3247; H04L 9/3265; H04L 2209/38; H04L 63/166; H04L 9/0825

(57) ABSTRACT

The present disclosure relates to a digital re-signing method for supporting various digital algorithms in a secure sockets layer (SSL) decryption device, and the method, if an SSL communication connection request between a client terminal and a server in the SSL decryption device is detected, requests an SSL session to the server to establish the SSL session between the SSL decryption device and the server, and obtains related information of the server, identifies a type of a digital signature algorithm designated when establishing the SSL session, creates a private certificate regarding the server using the related information of the server with the designated digital signature algorithm, and if the designated digital signature algorithm is not identical to a digital signature algorithm of a root certificate of the SSL decryption device, creates an intermediate certificate of the SSL decryption device with the designated digital signature algorithm, digitally signs the private certificate with the intermediate certificate, digitally signs the intermediate certificate with the root certificate of the SSL decryption device, creates a private certificate chain where the private certificate digitally signed with the intermediate certificate, the intermediate certificate digitally signed with the root certificate, and the root certificate are connected by chain, and transmits the private certificate chain to the client terminal.

### 1. FIELD

Embodiments disclosed hereinbelow relate to a digital re-signing method for supporting various digital signature algorithms in a secure sockets layer (SSL) decryption device, and more particularly, to support various digital signature algorithms with only one root certificate in the SSL decryption device.

### 2. BACKGROUND

In organizations such as companies, lots of information is being leaked outside through the Internet.

In order to prevent leakage of data, the companies inspect packets being transmitted from terminals in the company to check whether there is information that should not be leaked, gets approval, and transmit the approved packets to external servers through the Internet.

However, in cases where the server of the website that terminals try to connect uses secure sockets layer (SSL) communication, the contents of the packets are encrypted and then transmitted, and therefore, there is a problem of not being able to check whether there is information that should not be leaked.

SSL secure communication is an important information communication infrastructure. SSL technology that places importance on personal security made it difficult for existing security equipment to cope with hacker attacks from the outside and information leakage from the inside. In order to solve this problem, an SSL decryption device has been developed, that decrypts SSL communication in the middle of the network path and plays the role of inspection and control.

In SSL communication, it must be possible to not only encrypt the subject of communication but also perform the function of authenticating the identity of the counterpart. That is because it would be a problem if encrypted data is delivered to an unintended person. If the authentication function does not operate properly, encrypted information assets, electronic money and the like can be stolen through phishing. A communication subject of SSL provides X.509 certificate (hereinafter, certificate) to the counterpart in order to guarantee his/her identity, and when a certificate is provided, checks the identity of the counterpart based on the information disclosed in the certificate, and confirms the authenticity of the certificate through the digital signature attached to the certificate.

Meanwhile, certificates may have a multilayered structure. This relates to a problem of how to trust the digital signature of the certificate itself, and X.509 solves it by an approach scheme of the certificate authority together with the multilayered certificates. The multilayered certificates have a layered structure of a leaf, intermediate level 1, intermediate level 2, . . . intermediate level n, and root and for the leaf, the certificate at its upper level gives it the digital signature. This provides a chain of trust effect, and eventually comes down to a problem of how to trust the root certificate at the uppermost level. In SSL communication, the number of certificates at the uppermost level is small enough to be managed, and these are already installed on all PCs, mobile terminals and the like. A certificate connected from a root certificate, which is not installed on the device being used, cannot be relied upon in SSL communication.

In SSL communication, there are various kinds of digital signature algorithms used in signing certificates as shown below.
RSA (Rivest Shamir Adleman)
DSA (Digital Signature Algorithm)
ECDSA (Elliptic Curve Digital Signature Algorithm)
EdDSA (Edwards-curve Digital Signature Algorithm)

An SSL decryption device is located on an SSL communication path, and maintains two separate SSL communication sections; one being an SSL communication section between a client terminal and the SSL decryption device, and the other being an SSL communication section between the SSL decryption device and a server. In SSL communication, the SSL decryption device plays the role of a server to the client terminal. That is, the SSL decryption device provides a certificate representing the identity of the server to the client terminal, wherein the corresponding certificate is signed by a root certificate pre-installed in the client terminal. Upon receiving the corresponding certificate, if the certificate that signed the corresponding certificate is present in the list of the root certificate that the user trusts, the user will trust the corresponding certificate. That is, the user will trust the communication with SSL decryption devices as the communication with the server the user had originally intended to communicate with.

In X.509 standard itself, there is no particular limitation on the algorithm of the leaf certificate and its upper layer certificate that signs it. That is, even if the ECDSA root certificate signs the RSA certificate, there must not be any problem in operation. However, if this is not properly supported in old equipment, SSL communication cannot be performed properly.

As a coping method, it is possible to support only one type of digital signature algorithm instead of supporting numerous digital signature algorithms, that is, supporting only the most widely used RSA digital signature algorithm, and not supporting any other digital signature algorithm even when the user wants a more improved digital signature. Such an approach has a weakness in terms of security and is not an easily acceptable method considering that the purpose of using a general SSL decryption device is to improve the level of security.

There are other methods including a method of installing root certificates of all digital signal algorithms in the SSL decryption device, but in such a case, it is cumbersome to install the root certificates of all digital signature algorithms in each of the SSL decryption device and the terminal.

Therefore, there is a need for a method capable of supporting various digital signature algorithms even without installing root certificates of all the digital signature algorithms.

### SUMMARY

The present disclosure was derived in order to solve the aforementioned problems of prior art, that is, a purpose of the present disclosure is to provide an electronic re-signing method for supporting various digital signature algorithms in a secure sockets layer decryption device.

Specifically, the present disclosure relates to an SSL decryption device for relaying SSL communication between a client terminal and a server, and a purpose of the present disclosure is to connect from the SSL decryption device instead of the client terminal to a server that the client terminal intends to connect to, to create a private certificate that corresponds to a certificate of the server using the certificate of the server that the client terminal intends to connect to, to create a private certificate chain that includes the private certificate in order to enable authentication regardless of designated digital signature algorithms when establishing an SSL session and to provide the created private certificate chain to the client terminal, thereby providing a method for supporting various digital signature algorithms with only one root certificate in the SSL decryption device.

In order to achieve the aforementioned purpose, a digital re-signing method for supporting various digital signature algorithms in a secure sockets layer (SSL) decryption device according to an embodiment of the present disclosure includes detecting an SSL communication connection request between a client terminal and a server in the SSL decryption device; requesting an SSL session to the server to establish the SSL session between the SSL decryption device and the server, and obtaining related Information of the server; identifying a type of a digital signature algorithm designated when establishing the SSL session; creating a private certificate regarding the server using the related information of the server with the designated digital signature algorithm; if the designated digital signature algorithm is not identical to a digital signature algorithm of a root certificate of the SSL decryption device, creating an intermediate certificate of the SSL decryption device with the designated digital signature algorithm; digitally signing the private certificate with the intermediate certificate; digitally signing the intermediate certificate with the root certificate of the SSL decryption device; creating a private certificate chain where the private certificate digitally signed with the intermediate certificate, the intermediate certificate digitally signed with the root certificate, and the root certificate are connected by chain; and transmitting the private certificate chain to the client terminal.

Here, the digitally signing of the private certificate with the intermediate certificate may further include adding information of the digital signature algorithm of the server certificate received from the server as information of the signature algorithm of the private certificate, and creating a signature value using the signature algorithm and adding the created signature value to the private certificate.

Here, the digital re-signing method may further include, if the designated digital signature algorithm is identical to the digital signature algorithm of the root certificate of the SSL decryption device, digitally signing the private certificate with the root certificate; and transmitting the private certificate chain including the private certificate digitally signed with the root certificate and the root certificate to the client terminal.

Here, the digitally signing of the private certificate with the root certificate may further include adding information of the digital signature algorithm of the root certificate as the information of the signature algorithm of the private certificate, and creating a signature value using the signature algorithm and adding the created signature value to the private certificate.

Here, the digital re-signing method may further include, prior to the detecting of the SSL communication connection request, providing the root certificate to the client terminal and having the root certificate stored in the client terminal as a reliable certificate.

Here, the requesting of an SSL session to the server to establish the SSL session between the SSL decryption device and the server, and the obtaining of related information of the server may include creating a session key of the SSL decryption device; and encrypting the session key of the SSL decryption device using a public key included in the certificate of the server and transmitting the encrypted session key to the server.

Here, the obtaining of the related information of the server may include obtaining information of valid period, subject, alternative name of the subject, expanded key use, and basic limitations, as the related information of the server, from a server certificate received from the server in a process of establishing the SSL session between the SSL decryption device and the server.

Here, the creating of the private certificate regarding the server may include collecting information of an issuer from the root certificate of the SSL decryption device; creating information of a version, a serial number and a public key; and creating the private certificate that includes the related information of the server, the information collected from the root certificate, and the created information.

Here, the digital re-signing method may further include establishing the SSL session between the client terminal and the SSL decryption device using the private certificate chain.

Here, the establishing of the SSL session between the client terminal and the SSL decryption device using the private certificate chain may include receiving from the client terminal a session key of the client terminal, encrypted with a public key included in the private certificate; and decrypting the encrypted session key of the client terminal with a private key corresponding to the private certificate and obtaining the session key of the client terminal.

Here, the digital re-signing method may further include, after the SSL session is established between the SSL decryption device and the server, and the SSL session is established between the client terminal and the SSL decryption device, if a packet transmitted from the client terminal to the server is received, decrypting the packet using a session key of the client terminal; and encrypting the decrypted packet using the session key of the SSL decryption device, and transmitting the encrypted packet to the server.

Here, the encrypting of the decrypted packet using the session key of the SSL decryption device and the transmitting of the encrypted packet to the server may involve encrypting the decrypted packet and transmitting the encrypted packet to the server only when it is determined that transmitting is possible according to a result of inspecting whether the transmitting of the decrypted packet is approved.

Here, the digital re-signing method may further include, after the SSL session is established between the SSL decryption device and the server, and the SSL session is established between the client terminal and the SSL decryption device, if a packet transmitted from the server to the client terminal is received, decrypting the packet using a session key of the SSL decryption device; and encrypting the decrypted packet using the session key of the client terminal, and transmitting the encrypted packet to the client terminal.

Here, the encrypting of the decrypted packet using the session key of the client terminal and the transmitting of the encrypted packet to the client terminal may involve encrypting the decrypted packet and transmitting the encrypted packet to the server only when it is determined that transmitting is possible according to a result of inspecting whether the transmitting of the decrypted packet is approved.

The SSL decryption device of the present disclosure is capable of supporting numerous digital signature algorithms having improved security level, including RSA, with only one root certificate, and of solving the incompatibility that occurs when the algorithm of the leaf certificate and the algorithm of its immediate upper level certificate of the certificate provided to the client terminal are different from each other.

### BRIEF DESCRIPTION OF THE DRAWINGS

FIG. 1 is a view illustrating a schematic configuration of a security system capable of inspecting a packet in secure sockets layer communication according to an embodiment of the present disclosure;

FIG. 2 is a view illustrating a message flow connecting secure sockets layer communication through a secure sockets layer decryption device according to an embodiment of the present disclosure;

FIG. 3 is a view illustrating a message flow of transceiving a packet through a secure sockets layer decryption device according to an embodiment of the present disclosure;

FIG. 4 is a flowchart illustrating a process for connecting to the secure sockets layer communication between a client terminal and a server in a secure sockets layer decryption device according to an embodiment of the present disclosure; and

FIG. 5 is a view illustrating an example of creating a component of a private certificate according to an embodiment of the present disclosure.

### DETAILED DESCRIPTION

Hereinbelow, embodiments will be described in detail with reference to the drawings attached. However, various modifications can be made to the embodiments, and thus the scope of rights of the patent application is not limited or restricted by those embodiments. It should be understood that all changes, equivalents, or substitutes to the embodiments are included in the scope of rights.

Terms used in the embodiments are used for illustrative purposes only and should not be construed as limiting. Singular expressions include plural expressions unless the context clearly indicates otherwise. It should be understood that, in the present specification, the terms “comprises/includes” or “have/has” intend to designate the presence of the mentioned characteristic, number, step, operation, element, component or a combination thereof, and not to exclude the possibility of presence or addition of one or more other characteristic, number, step, operation, element, component or a combination thereof.

Unless defined otherwise, all the terms used in the present specification including technical or scientific terms have the same meaning as would be commonly understood by those in the art which the embodiments pertain to. Further, terms such as those defined in generally used dictionaries should be construed as having a meaning consistent with the meaning in the context of the related art, and unless defined clearly in the present specification, should not be construed ideally or overly.

Further, in describing the present disclosure with reference to the drawings attached, regardless of the reference numerals, like reference numerals indicate like components, and redundant descriptions thereof will be omitted. In describing the embodiments, when it is determined that a detailed description of a related known technology may unnecessarily obscure the subject matter of the embodiment, a detailed description thereof will be omitted.

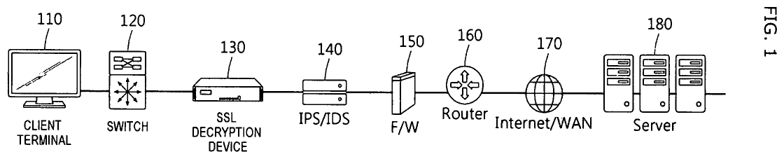

FIG. 1 is a view illustrating a schematic configuration of a security system capable of inspecting a packet in secure sockets layer communication according to an embodiment of the present disclosure.

Referring to FIG. 1, when connecting to the Internet 170 from a client terminal 110 in a network environment, the client terminal 110 may be connected to a switch 120. By being connected to the switch 120, the client terminal 110 may be connected to the network and may be able to transmit data. Here, as for the client terminal 110, at least one or more clients may be connected to the Internet. For example, the client may be terminals such as PC and smart phone.

An SSL decryption device 130 is a kind of gateway device that may perform the role of a proxy server, and may monitor web communication of the client terminal 110.

If the SSL decryption device 130 detects a connection from the client terminal 110 to a server 180 that uses secure sockets layer (SSL) communication while monitoring, the SSL decryption device 130 establishes an SSL session between the SSL decryption device 130 and the server 180 using a certificate of the server, creates a private certificate using the certificate of the server, creates a private certificate chain that includes the private certificate, and establishes a secure sockets layer session between the client terminal 110 and the SSL decryption device 130 using the private certificate chain, thereby playing the role of relaying and inspecting packets transceived between the client terminal 110 and the server 180.

Here, the SSL decryption device 130 creates the private certificate chain in different ways depending on whether a digital signature algorithm designated when establishing the SSL session with the server 180 is identical to a digital signature algorithm of a root certificate of the SSL decryption device 130.

If the digital signature algorithm designated when establishing the SSL session with the server 180 is identical to the digital signature algorithm of the root certificate of the SSL decryption device 130, the SSL decryption device 130 digitally signs the private certificate with the root certificate of the SSL decryption device 130, and creates the private certificate chain that includes the private certificate digitally signed with the root certificate, and the root certificate.

If the digital signature algorithm designated when establishing the SSL session with the server 180 is not identical to the digital signature algorithm of the root Certificate of the SSL decryption device 130, the SSL decryption device 130 creates an intermediate certificate of the SSL decryption device 130 with the designated digital signature algorithm, digitally signs the private certificate with the intermediate certificate, digitally signs the intermediate certificate with the root certificate of the SSL decryption device 130, and creates the private certificate chain where the private certificate digitally signed with the intermediate certificate, the intermediate certificate digitally signed with the root certificate, and the root certificate are connected by chain.

Here, the intermediate certificate is located between the root certificate of the SSL decryption device 130 and the leaf certificate (private certificate) of the SSL decryption device 130.

Meanwhile, the SSL decryption device 130 predetermines the root certificate, and provides the root certificate to the client terminal 110 in advance, so that the root certificate is stored in the client terminal 110 as a reliable certificate. That is, the client terminal 110 stores the root certificate of the SSL decryption device 130 as a reliable certificate.

In addition, when a packet is transmitted from the client terminal 110 to the server 180 in a network environment, the packet may be transmitted through an IPS/IDS 140, a firewall 150, and a router 160.

Here, the intrusion detection system (IPS)/intrusion prevention system (IDS) 140 relates to a system for detecting and preventing an intrusion. The IPS/IDS 140 may detect a harmful packet pattern.

In addition, the firewall 150 may perform a function of filtering connection of an IP and the like or filtering an application.

Here, the IPS/IDS 140, the firewall 150 or the router 160 may be omitted depending on circumstances.

Hereinbelow, a digital re-signing method to support various digital signature algorithms in a secure sockets layer decryption device and a method for inspecting a packet using secure sockets layer communication according to the present disclosure will be described with reference to the drawings attached.

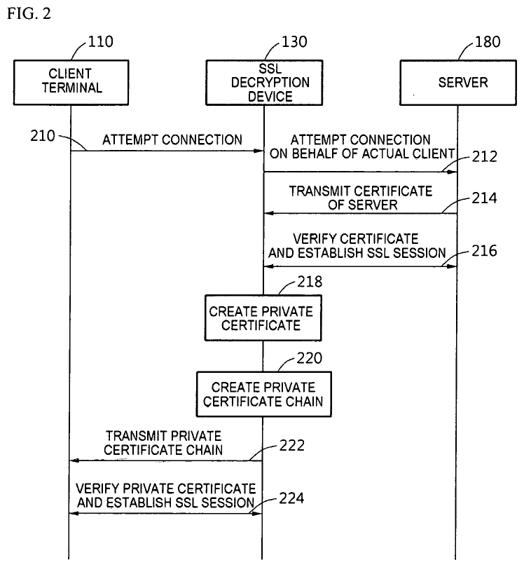

FIG. 2 is a view illustrating a message flow for connecting to secure sockets layer communication through a secure sockets layer decryption device according to an embodiment of the present disclosure.

Referring to FIG. 2, the client terminal 110 may attempt to connect to the server 180 using secure sockets layer communication (210).

If the SSL decryption device 130 detects a connection from the client terminal 110 to the server 180 using the secure sockets layer communication, the SSL decryption device 130 attempts to connect to the corresponding server instead of the client terminal 110 (212).

In addition, if there is no certificate of the server 180, the SSL decryption device 130 makes a request for the certificate of the server 180 to the server 180, and receives the certificate (214).

In addition, the SSL decryption device 130 verifies the certificate of the server 180, and the SSL decryption device 130 and the server 180 establishes a secure sockets layer (SSL) session between the SSL decryption device 130 and the server 180 using the certificate of the server (216).

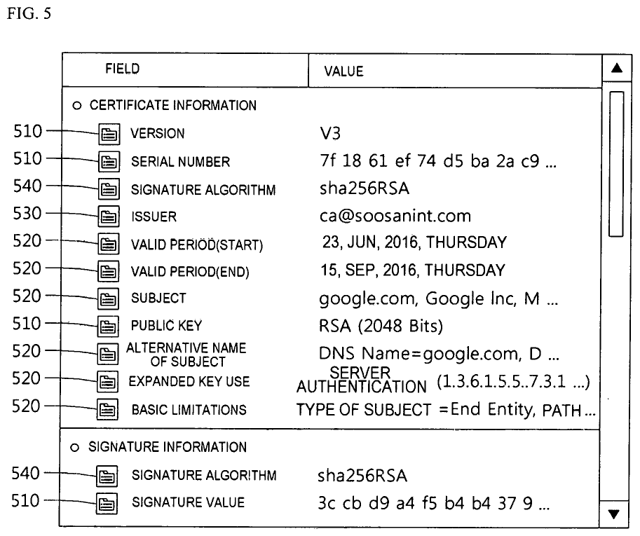

In addition, the SSL decryption device 130 may create the private certificate corresponding to the server using the certificate of the server and the root certificate of the SSL decryption device 130 in the method of FIG. 5 described hereinbelow (218).

FIG. 5 is a view illustrating an example for creating a component of the private certificate according to an embodiment of the present disclosure.

Referring to FIG. 5, the components of the private certificate are created through three methods.

The three methods for creating the component of the private certificate include a method of creating the component in the SSL decryption device 130 (510), a method of bringing the component from the certificate of the server 180 that the client terminal 110 intends to connect to (520), a method of bringing the component from the root certificate of the SSL decryption device 130 (530), and a method of selectively bringing the component from the root certificate of the SSL decryption device 130 or the certificate of the server 180 that the client terminal 110 intends to connect to depending on whether the designated digital signature algorithm is identical to the digital signature algorithm of the root certificate of the SSL decryption device 130 (540).

The method of 520 creates the component of the private certificate by bringing information of valid period, subject, alternative name of subject, expanded key use and basic limitations, from the actual certificate (server certificate) of the server 180 that the client terminal 110 intends to connect to.

The method of 530 brings information of the issuer from the root certificate of the SSL decryption device 130 and creates the component of the private certificate.

The method of 510 creates information of the version, serial number, public key and signature value depending on the setting criteria of the SSL decryption device 130. Here, the signature value may be created using the signature algorithm.

If the designated digital signature algorithm is identical to the digital signature algorithm of the root certificate of the SSL decryption device 130, the method of 540 brings information of the signature algorithm from the root certificate of the decryption device 130, and creates the component of the private certificate. That is, the corresponding digital signature algorithm based on the public key type of the root certificate may be identified as the information of the signature algorithm 540.

If the designated digital signature algorithm is not identical to the digital signature algorithm of the root certificate of the SSL decryption device 130, the method 540 brings the information of the signature algorithm from the certificate (server certificate) of the server 180 and creates the component of the private certificate. That is, the corresponding digital signature based on the public key type of the server certificate may be identified as the information of the signature algorithm.

Here, the signature algorithm identified at the method of 540 represents both the signature algorithm included in the certificate information and the signature algorithm included in the signature information.

Creating the private certificate was described through the example of FIG. 5, but the method of creating the private certificate of the present disclosure is not limited to FIG. 5. The private certificate may be created in various methods.

Back to FIG. 2, the SSL decryption device 130 creates the private certificate chain using the private certificate (220).

Here, at step 220, the SSL decryption device 130 creates the private certificate chain in different methods depending on whether the designated digital signature algorithm is identical to the digital signature algorithm of the root certificate of the SSL decryption device 130.

If the designated digital signature algorithm is identical to the digital signature algorithm of the root certificate of the SSL decryption device, the SSL decryption device 130 digitally signs the private certificate with the root certificate of the SSL decryption device 130, and creates the private certificate chain that includes the private certificate that is digitally signed with the root certificate and the root certificate.

If the designated digital signature algorithm is not identical to the digital signature algorithm of the root certificate of the SSL decryption device 130, the SSL decryption device 130 creates the intermediate certificate of the SSL decryption device 130 with the designated digital signature algorithm, digitally signs the private certificate with the intermediate certificate, digitally signs the intermediate certificate with the root certificate of the SSL decryption device 130, and creates the private certificate chain where the private certificate digitally signed with the intermediate certificate, the intermediate certificate digitally signed with the root certificate, and the root certificate are connected by chain.

In addition, the SSL decryption device 130 provides the private certificate chain to the client terminal 110 (222).

In the client terminal 110, the private certificate is verified through the root certificate included in the private certificate chain, and the client terminal 110 and the SSL decryption device 130 establishes an SSL session between the client terminal 110 and the SSL decryption device 130 using the private certificate (224).

That is, the SSL decryption device 130 may establish the SSL session between the client terminal 110 and the server 180 with the client terminal 110, and establish the SSL session with the server 180, so as to play the role of inspecting and relaying a packet transceived.

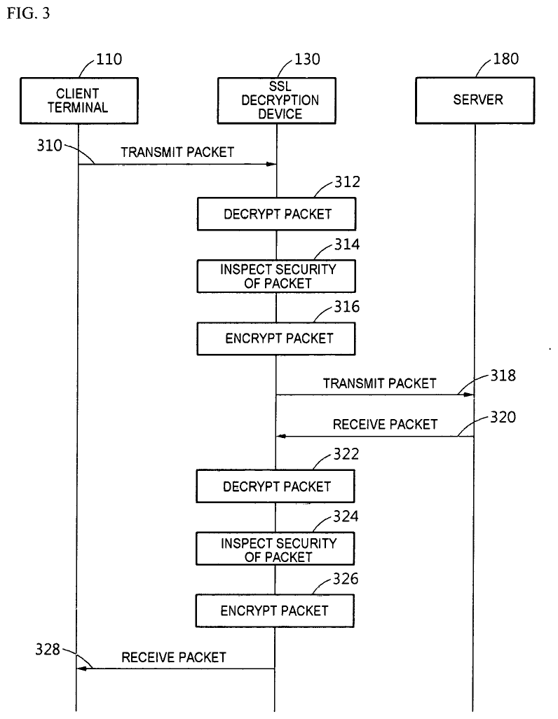

FIG. 3 is a view illustrating a message flow where a packet is being transceived through the secure sockets layer decryption device according to an embodiment of the present disclosure.

Referring to FIG. 3, if the SSL decryption device 130 receives a packet transmitted from the client terminal 110 to the server 180 (310), the SSL decryption device 130 decrypts the packet using a session key of the client terminal (312).

In addition, the SSL decryption device 130 inspects whether there is an approval for transmitting the decrypted packet (314).

In addition, if the decrypted packet is able to be transmitted according to a result of the inspection on whether there is an approval for transmitting the decrypted packet, the SSL decryption device 130 encrypts the decrypted packet using the session key of the SSL decryption device 130 (316), and transmits the packet encrypted with the session key of the SSL decryption device 130 to the server 180 (318).

Meanwhile, depending on the setting, instead of inspecting whether there is approval for transmitting the decrypted packet at step 314, the SSL decryption device 130 may store the decrypted packet in a storage device, and then at step 316, regardless of whether there is approval for transmitting the decrypted packet, the SSL decryption device 130 may encrypt the decrypted packet using the session key of the SSL decryption device 130, and at step 318, transmit the encrypted packet to the server 180.

If the SSL decryption device 130 receives the packet transmitted from the server 180 to the client terminal 110 (320), the SSL decryption device 130 decrypts the packet using the session key of the SSL decryption device 130 (322).

In addition, the SSL decryption device 130 inspects whether there is approval for transmitting the decrypted packet (324).

In addition, if the decrypted packet is able to be transmitted according to a result of the inspection on whether there is approval for transmitting the decrypted packet, the SSL decryption device 130 encrypts the decrypted packet using the session key of the client terminal 110 (326), and transmits the packet encrypted with the session key of the client terminal 110 to the client terminal 110 (328).

Meanwhile, depending on the setting, instead of inspecting whether there is approval for transmitting the decrypted packet at step 324, the SSL decryption device 130 may store the decrypted packet in the storage device, and then at step 326, regardless of whether there is approval for transmitting the decrypted packet, the SSL decryption device 130 may encrypt the decrypted packet using the session key of the client terminal 110, and at step 328, transmit the encrypted packet to the client terminal 110.

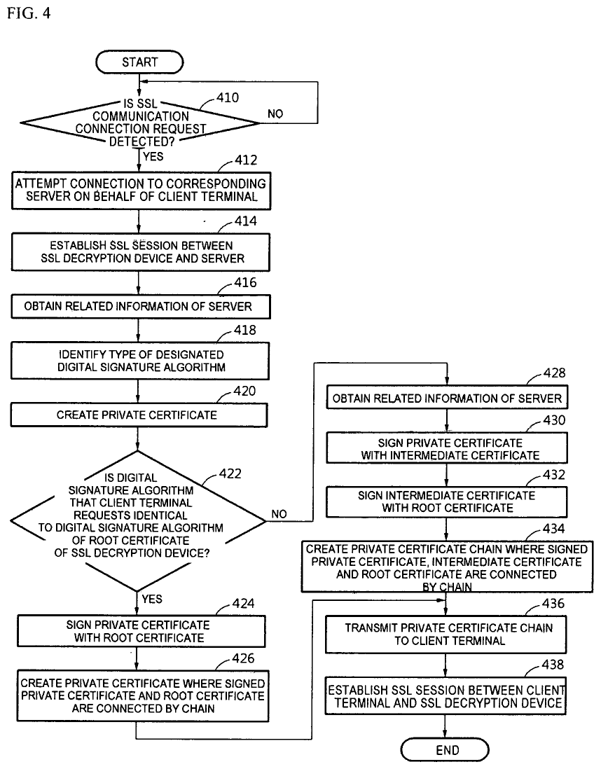

FIG. 4 is a flowchart illustrating a process of connecting secure sockets layer communication between a client terminal and a server in a secure sockets layer decryption device according to an embodiment of the present disclosure.

The SSL decryption device 130 attempts to connect to a corresponding server 180 by requesting an SSL session on behalf of the client terminal 110 (412).

In addition, the SSL decryption device 130 establishes an SSL session between the SSL decryption device 130 and the server 180 (414). At step 414, the SSL decryption device 130 may create a session key of the SSL decryption device 130, and establish the SSL session by encrypting the session key of the SSL decryption device 130 using a public key included in the certificate of the server 180 and transmitting the encrypted session key to the server 180.

In addition, the SSL decryption device 130 obtains related information of the server (416). Here, at step 418, the SSL decryption device 130 may identify information of the valid period, subject, alternative name of subject, expanded key use and basic limitations from the server certificate and obtain the information as the related information of the server.

In addition, the SSL decryption device 130 identifies the type of the digital signature algorithm designated when establishing the SSL session (418).

In addition, the SSL decryption device 130 creates the private certificate regarding the server 180 using the related information of the server (420). At step 420, the SSL decryption device 130 may create information of the version and serial number of the SSL decryption device 130, and create the private certificate that includes the related information of the server, information collected from the root certificate, and the created information. Here, the SSL decryption device 130 may create rest of the information included in the private certificate except for the information of the signature algorithm and the signature value.

In addition, the SSL decryption device 130 identifies whether the designated digital signature algorithm is identical to the digital signature algorithm of the root certificate of the SSL decryption device 130 (422).

If the designated digital signature algorithm is identical to the digital signature algorithm of the root certificate of the SSL decryption device 130 according to a result of the identification at step 422, the SSL decryption device 130 digitally signs the private certificate with the root certificate of the SSL decryption device 130 (424). When signing the private certificate with the root certificate at step 424, the SSL decryption device 130 records the corresponding digital signature algorithm based on the public key type of the root certificate (digital signature algorithm of the root certificate) as the information of the signature algorithm 540, creates the signature value using the corresponding signature algorithm, and adds the created signature value to the private certificate.

In addition, the SSL decryption device 130 creates the private certificate chain that includes the private certificate digitally signed with the root certificate and the root certificate (426).

If the designated digital signature algorithm is not identical to the digital signature algorithm of the root certificate of the SSL decryption device 130 according to a result of the identification at step 422, the SSL decryption device 130 creates the intermediate certificate of the SSL decryption device 130 with the designated digital signature algorithm (428). Here, the intermediate certificate is located between the root certificate of the SSL decryption device 130 and the leaf certificate (private certificate) of the SSL decryption device 130.

In addition, the SSL decryption device 130 digitally signs the private certificate with the intermediate certificate (430). When signing the private certificate with the intermediate certificate at step 430, the SSL decryption device 130 records the corresponding digital signature algorithm based on the public key type of the server certificate (digital signature algorithm of the server certificate) as the information of the signature algorithm 540, and creates the signature value using the corresponding signature algorithm, and adds the created signature value to the private certificate.

In addition, the SSL decryption device 130 digitally signs the intermediate certificate with the root certificate of the SSL decryption device 130 (432).

In addition, the SSL decryption device 130 creates the private certificate chain where the private certificate digitally signed with the intermediate certificate, the intermediate certificate digitally signed with the root certificate, and the root certificate are connected by chain (434).

In addition, the SSL decryption device 130 transmits the private certificate chain created at step 426 and the private certificate chain created at step 434 to the client terminal 110 (436).

By creating the intermediate certificate with the designated digital signature algorithm in the SSL decryption device 130, and then using the created intermediate certificate, it is possible to solve the error of incompatibility in the case that the leaf certificate and its immediately upper level certificate have different algorithms, which may occur in the client terminal 110.

In addition, the SSL decryption device 130 establishes the SSL session between the client terminal 110 and the SSL decryption device 130 using the private certificate chain (438). At step 438, the SSL decryption device 130 may receive the session key of the client terminal encrypted with the public key included in the private certificate from the client terminal 110, and decrypt the session key of the client terminal encrypted with a private key corresponding to the private certificate and obtain the session key of the client terminal, to establish the SSL session.

A method according to the embodiment described above may be implemented in the form of program instructions that may be performed through various computer means, and may be recorded in a computer readable medium. The computer readable medium may include program instructions, data files, data structures and the like solely or in combinations. The program instructions being recorded in the medium described above may be those specially designed or configured or those well known and available to a person skilled in computer software. Examples of the computer readable recording medium include magnetic media such as hard disks, floppy disks, and magnetic tapes, optical media such as CD-ROMs and DVDs, and magnetic media such as floptical disks, and hardware devices specially configured to store and execute program instructions such as ROM, RAM, flash memory, etc. Examples of program instructions include not only machine language codes such as those produced by a compiler, but also high-level language codes that can be executed by a computer using an interpreter. The hardware device may be configured to operate as one or more software modules in order to perform the operations of the embodiment, and vice versa.

Software may include computer programs, codes, instructions, or combinations of one or more thereof, and may configure a processing device to operate as desired, or independently or collectively instruct the processing device. Software and/or data may be embodied permanently or temporarily in any type of machine, component, physical device, virtual equipment, computer storage medium or device, or signal wave being transmitted. Software may be dispersed on a computer system connected by a network, and may be stored or implemented in a dispersed method. Software and data may be stored in one or more computer readable record medium.

Although the embodiments have been described by the limited drawings as described above, a person of ordinary skill in the art may apply various technical modifications and variations based on the above. For example, the described technologies may be performed in an order different from the described method, and/or a component such as a system, structure, device, circuit, and the like described may be combined in a form different from the described method, or even if alternated or substituted by other components or equivalents, an appropriate result may be achieved.

Therefore, other implementations, other embodiments, and equivalents to the claims also fall within the scope of the claims to be described hereinafter.

### REFERENCE NUMERALS

110: CLIENT TERMINAL
120: SWITCH
130: SSL DECRYPTION DEVICE
140: IPS/IDS
150: FIREWALL
160: ROUTER
170: INTERNET
180: SERVER

1. A digital re-signing method for supporting various digital signature algorithms in a secure sockets layer (SSL) decryption device, comprising:
detecting an SSL communication connection request between a client terminal and a server in the SSL decryption device;
requesting an SSL session to the server so as to establish the SSL session between the SSL decryption device and the server, and obtaining related information of the server;
identifying a type of a digital signature algorithm designated when establishing the SSL session;
creating a private certificate regarding the server using the related information of the server with the designated digital signature algorithm;
if the designated digital signature algorithm is not identical to a digital signature algorithm of a root certificate of the SSL decryption device, creating an intermediate certificate of the SSL decryption device with the designated digital signature algorithm;
digitally signing the private certificate with the intermediate certificate;
digitally signing the intermediate certificate with the root certificate of the SSL decryption device;
creating a private certificate chain where the private certificate digitally signed with the intermediate certificate, the intermediate certificate digitally signed with the root certificate, and the root certificate are connected by chain; and
transmitting the private certificate chain to the client terminal.

2. The digital re-signing method for supporting various digital signature algorithms in a secure sockets layer (SSL) decryption device, according to claim 1,
wherein the digitally signing of the private certificate with the intermediate certificate further comprises adding information of the digital signature algorithm of the server certificate received from the server as information of the signature algorithm of the private certificate, and creating a signature value using the signature algorithm and adding the created signature value to the private certificate.

3. The digital re-signing method for supporting various digital signature algorithms in a secure sockets layer (SSL) decryption device, according to claim 1,
further comprising, if the designated digital signature algorithm is identical to the digital signature algorithm of the root certificate of the SSL decryption device, digitally signing the private certificate with the root certificate; and
transmitting the private certificate chain including the private certificate digitally signed with the root certificate and the root certificate to the client terminal.

4. The digital re-signing method for supporting various digital signature algorithms in a secure sockets layer (SSL) decryption device, according to claim 3,
wherein the digitally signing of the private certificate with the root certificate further comprises adding information of the digital signature algorithm of the root certificate as the information of the signature algorithm of the private certificate, and creating a signature value using the signature algorithm and adding the created signature value to the private certificate.

5. The digital re-signing method for supporting various digital signature algorithms in a secure sockets layer (SSL) decryption device, according to claim 1,
further comprising, prior to the detecting of the SSL communication connection request, providing the root certificate to the client terminal and having the root certificate stored in the client terminal as a reliable certificate.

6. The digital re-signing method for supporting various digital signature algorithms in a secure sockets layer (SSL) decryption device, according to claim 1,
wherein the requesting of the SSL session to the server so as to establish the SSL session between the SSL decryption device and the server, and the obtaining of related information of the server comprises:
creating a session key of the SSL decryption device; and
encrypting the session key of the SSL decryption device using an public key included in the certificate of the server and transmitting the encrypted session key to the server.

7. The digital re-signing method for supporting various digital signature algorithms in a secure sockets layer (SSL) decryption device, according to claim 1,
wherein the obtaining of the related information of the server comprises obtaining information of valid period, subject, alternative name of the subject, expanded key use, and basic limitations, as the related information of the server, from a server certificate received from the server in a process of establishing the SSL session between the SSL decryption device and the server.

8. The digital re-signing method for supporting various digital signature algorithms in a secure sockets layer (SSL) decryption device, according to claim 1,
wherein the creating of the private certificate regarding the server comprises:
collecting information of an issuer from the root certificate of the SSL decryption device;
creating information of a version, a serial number and an public key; and
creating the private certificate that includes the related information of the server, the information collected from the root certificate, and the created information.

9. The digital re-signing method for supporting various digital signature algorithms in a secure sockets layer (SSL) decryption device, according to claim 1,
further comprising establishing the SSL session between the client terminal and the SSL decryption device using the private certificate chain.

10. The digital re-signing method for supporting various digital signature algorithms in a secure sockets layer (SSL) decryption device, according to claim 9,
wherein the establishing of the SSL session between the client terminal and the SSL decryption device using the private certificate chain comprises:
receiving from the client terminal a session key of the client terminal, encrypted with an public key included in the private certificate; and
decrypting the encrypted session key of the client terminal with a private key corresponding to the private certificate and obtaining the session key of the client terminal.

11. The digital re-signing method for supporting various digital signature algorithms in a secure sockets layer (SSL) decryption device, according to claim 1,
further comprising, after the SSL session between the SSL decryption device and the server is established, and the SSL session between the client terminal and the SSL decryption device is established,
if a packet transmitted from the client terminal to the server is received, decrypting the packet using a session key of the client terminal; and
encrypting the decrypted packet using the session key of the SSL decryption device, and transmitting the encrypted packet to the server.

12. The digital re-signing method for supporting various digital signature algorithms in a secure sockets layer (SSL) decryption device, according to claim 11,
wherein the encrypting of the decrypted packet using the session key of the SSL decryption device and the transmitting of the encrypted packet to the server involves encrypting the decrypted packet and transmitting the encrypted packet to the server only when it is determined that the decrypted packet is able to be transmitted according to a result of inspecting whether the transmitting of the decrypted packet is approved.

13. The digital re-signing method for supporting various digital signature algorithms in a secure sockets layer (SSL) decryption device, according to claim 1,
further comprising, after the SSL session between the SSL decryption device and the server is established, and the SSL session between the client terminal and the SSL decryption device is established,
if a packet transmitted from the server to the client terminal is received, decrypting the packet using a session key of the SSL decryption device; and
encrypting the decrypted packet using the session key of the client terminal, and transmitting the encrypted packet to the client terminal.

14. The digital re-signing method for supporting various digital signature algorithms in a secure sockets layer (SSL) decryption device, according to claim 13,
wherein the encrypting of the decrypted packet using the session key of the client terminal and the transmitting of the encrypted packet to the client terminal involves encrypting the decrypted packet and transmitting the encrypted packet to the server only when it is determined that the decrypted packet is able to be transmitted according to a result of inspecting whether the transmitting of the decrypted packet is approved.

15. A computer-readable recording medium where a program for executing a method according to claim 1 is recorded.

16. A computer-readable recording medium where a program for executing a method according to claim 2 is recorded.
